(19) United States
(12) Patent Application Publication
(10) Pub. No.: US 2008/0184936 A1
(43) Pub. Date: Aug. 7, 2008

(54) Milking Arrangement

(75) Inventors: Torbjorn Petterson, Gnesta (SE); Soren Lundin, Marsta (SE)

Correspondence Address: HOVEY WILLIAMS LLP, 10801 Mastin Blvd., Suite 1000, Overland Park, KS, 66210, US

(73) Assignee: DELAVAL HOLDING AB, Tumba (SE)

(21) Appl. No.: 11/722,311

(22) PCT Filed: Oct. 10, 2005
(86) PCT No.: PCT/SE05/01495

§ 371 Date: Jun. 20, 2007

(30) Foreign Application Priority Data
Dec. 20, 2004 (SE) 0403095-3

(51) Int. Cl. A01J 5/007; A01J 5/017

(52) U.S. Cl. 119/14.02; 119/14.08

(57) ABSTRACT

A milking arrangement (1) and a method for milking are described comprising at least two milking positions (2), wherein each milking position (2) comprises teat cups (4) for milking an animal (3). The milking arrangement (1) is arranged to remove the teat cups (4) from animals when milking is finished and to remove the teat cups (4) from all animals (3) that are still being milked when all conditions in a set of conditions are fulfilled, wherein the set of conditions comprises the condition that the teat cups (4) have been removed from a predetermined number of animals (3) and that all animals (3) that are still being milked, in an earlier milking preceding the present milking, must have been milked until the milking was determined to be substantially finished.

### TECHNICAL FIELD

The present invention relates to a milking arrangement for milking animals according to the preamble of the independent device claim and to a method according to the preamble of the independent method claim.

### DESCRIPTION OF THE PRIOR ART

Milking arrangements have been used for a number of years to milk cows which are allowed to go loose. There are a number of different types of milking arrangements with a number of milking positions or milking stalls, wherein the animals are milked. In order to reduce the manual work involved with manual milking, machines have been used to perform different parts of the milking operation, such as the application and the removal of teat cups on the animals. One type of milking arrangement is known as automatic milking system in which the animals enter the milking position on a voluntary basis. The milking stalls or milking positions may be arranged in a number of different ways in a milking arrangement.

It is desirable that the milking of the animals in the milking positions is finished as soon as possible as this allows a new animal to enter the milking position. In the PCT application WO 02/054857 A1 a method for optimization of milking in an automatic milking facility is disclosed, according to which the milk flow from each teat is monitored. When the milk flow from three of four teats have gone below a predetermined threshold the threshold is raised for the fourth teat so that the milking of the fourth teat is interrupted earlier than would otherwise have been the case.

The milking positions may be arranged so that a group of animals are milked simultaneously and released from the milking positions when the milking is finished. Thus, new animals are not allowed to enter the milking arrangement until all milking positions are empty. Such milking is known as batch milking. The milking positions in such a milking arrangement may be arranged in a herringbone arrangement, or in a parallel arrangement. Also other arrangements of the milking positions are possible. A problem in such milking arrangements is that the use of the milking arrangement is not optimized as the milking is finished at different times for different animals.

One way of improving the utilisation of the milking arrangement is to allow animals to enter the milking positions in which the milking is finished. This means that animals from different groups are mixed. It is, however, not always possible/desirable to mix the animals from different groups.

The patent application US 2002/0148408 describes a milk flow monitor and a milker unit detacher. The milker unit detacher removes the teat cups in response to the milk flow monitored with the milk flow monitor. The patent application is directed to the problem of optimising throughput in a milking arrangement.

### SUMMARY OF THE INVENTION

An object of the present invention is to provide an alternative to the present milking arrangements, which allows for an efficient milking when at least two animals are milked simultaneously.

Another object of the present invention is to provide an efficient method for milking, when at least two animals are milked simultaneously.

These objects are achieved with a milking arrangement and a method according to the independent claims.

Further advantages are achieved with the features of the dependent claims.

A milking arrangement for simultaneous milking of at least two animals according to the present invention comprises at least two milking positions, wherein each milking position comprises teat cups for milking an animal, a removing member for removal of the teat cups from the animals and determining means for determining when milking is finished. The removing members are arranged to remove the teat cups from the animals when milking is finished. The milking arrangement is characterised in that the milking arrangement is arranged to remove the teat cups from all animals that are still being milked, using the removing member, when all conditions in a set of conditions are fulfilled. The set of conditions comprises the conditions that the teat cups have been removed from a predetermined number of animals and that all animals that are still being milked, in an earlier milking preceding the present milking, must have been milked until milking was substantially finished.

With a milking arrangement according to the present invention the milking may be made more efficient as the milking is interrupted for the animals requiring most time in the milking arrangement. Although the conditions mentioned above may be the only conditions in the set of conditions, the set of conditions may alternatively comprise more conditions.

The time it takes to milk an animal may differ a lot between different animals. In case an animal requires longer time to be milked than other animals it is possible that the milking is interrupted more often for that animal. It is, however, not healthy for the animals if they are never milked until their udders are essentially empty, as there is a risk for animals to develop diseases like mastitis under such conditions. To this end the set of conditions comprises the condition that all animals that are still being milked, in an earlier milking preceding the present milking, must have been milked until milking was finished. With such a condition the risk for diseases such as mastitis is minimised.

With substantially finished is meant that a large part of the milking has been finished in a preceding milking.

The earlier milking must preferably have occurred no earlier than within a maximum number of milkings preceding the present milking or a maximum time limit preceding the present milking. This is most important during the part of the lactation period in which the animal is usually milked two or more times per day. After said part of the lactation period, i.e. at the end of the lactation period, the milking frequency is often decreased. The milking arrangement according to the present invention is primarily intended for batch milking.

The teat cups may be attached to the teats of an animal either by an operator of the milking arrangement or by a robot. The invention is primarily intended for milking arrangements with a large number of animals in which the teat cups are applied by an operator.

With a milking arrangement for simultaneous milking is meant a milking arrangement in which it is possible to milk animals simultaneously in a number of milking positions.

Milking may be determined to be finished using one of a number of different criteria. The milking may be determined to be finished when a predetermined time has elapsed from the start of milking of that particular animal. The predetermined time may be individual for each animal. The predetermined time is preferably based on earlier measurements of milk yield, in such a way that milking was finished during the predetermined time.

The determining means may be arranged to determine the milk flow from the animal in each milking position during milking. Milking may be determined to be finished when the milk flow from the animal is below a predetermined threshold. This is a relatively easy way of determining when milking is finished. The milking may be considered to have been substantially finished if the milk flow has been within a predetermined percentage of the threshold from the threshold during any earlier milking. The percentage may for example be in the range 5-15%. The milk flow may be measured with a flow meter. Alternatively, the milk flow may be measured indirectly by measuring the totally milked volume as a function of the time. In such a case the milk flow is the derivative of the totally milked volume.

An alternative way of determining when milking is finished would be to, e.g. measure the total milked volume from the start of the milking and to consider the milking to be finished when a threshold is reached. In this case the milking may be considered to have been substantially finished if the milk volume was within a predetermined percentage of the threshold from the threshold during an earlier milking. The percentage may for example be in the range 5-15%.

It is not necessary to use the same threshold for all animals but a unique threshold for the milk flow or the milk volume may be arranged for each animal. It is also possible to have a unique threshold for each quarter/teat.

The maximum number of milkings is preferably in the range 1-10 milkings and most preferred in the range 2-5 milkings, depending on the milking frequency.

When a maximum number of milkings as mentioned above is used in order to avoid that the animals get mastitis the animals have to be identified in some way. It is possible within the scope of the invention that the identification is performed manually as the animals enter the respective milking positions. It is, however, preferred that the milking arrangement comprises animal identification means for identifying animals entering the milking positions.

As an alternative to or combined with the above mentioned maximum number of milkings a time limit may be used, wherein the earlier milking must have occurred no earlier than within a maximum time limit preceding the present milking. By having a maximum time limit it is possible to take into account different milking frequencies at which animals are milked at different milking arrangements.

The maximum time limit is preferably in the range 15-50 hours and more preferred in the range 20-30 hours. The latter is a proper range when the cows are milked at a frequency of 3 times per day.

As mentioned above the milking may be considered to have been substantially finished if the milk flow has been within a predetermined percentage of the threshold from the threshold during any earlier milking. The criteria may be used that this must have occurred within the predetermined maximum number of milkings or maximum time limit. Thus, if a milking has occurred within the predetermined maximum number of milkings and/or within the maximum time limit, wherein the milking was within the predetermined percentage from the threshold, milking may be considered to have been substantially finished. The percentage may be in the range 5%-15%, i.e. the milk flow or the milk volume was within 5%-15% from the threshold during any milking within the maximum time limit and/or the maximum number of milkings.

It is also possible to use an additional criteria in case the milking was interrupted during the maximum number of milkings and/or the maximum time limit. In such a case it may be determined whether the milking was interrupted during a second maximum number of milkings and/or a second maximum time limit. If this is the case the percentage for the milking to be considered to be substantially finished may be lowered to e.g. 2%-7%. The second maximum time limit and the second maximum number of milkings may be a multiple of a factor and the maximum time limit and the maximum number of milkings, respectively. The factor may be in the range 1.5-4.

The milking arrangement may comprise an access device, which animals have to pass before entering the milking positions. By incorporating an access device it becomes more easy to control which animals that pass into the milking positions.

In case the milking arrangement comprises an access device the animal identification means may be arranged in the access device, identifying animals passing through the access device. By determining into which milking position each animal goes after having been identified it is possible to determine the identity of the animals in the milking positions.

It is also possible to have animal identification means arranged in at least one of the milking positions. This may be a complement to the animal identification means in the access device to make certain that the animals are where they are expected to be.

Animal identification means may be arranged in each one of the milking positions. If this is the case it is not necessary to have any more animal identification means in the milking arrangement. A drawback with having an animal identification means in each milking position is that it is costly.

The milking arrangement may comprise means for measuring and registering the milking times for each animal. This information may be used in a number of different ways. The time at which the milking occurred may also be registered. Also other data may be measured and registered.

The milking arrangement may be arranged to indicate milking positions in which animals are present, for which animals any previous milking prior to the present milking have taken longer time than for the majority of the animals. With such means for indicating it becomes possible for an operator of the milking arrangement to start attaching teat cups on animals requiring a long milking time. This may decrease the possibility for such animals to have their milking interrupted because of the animal being the last to be milked.

The milking arrangement may be arranged to milk a first group of animals, for which group of animals any previous milking has taken shorter time than for the majority of the animals, differently from the other animals in the milking arrangement. In other words, it is possible to milk such animals more slowly and more gently as they otherwise would have to wait for the other animals to be finished milking.

There are many variants for milking the animals differently. According to one variant a lower milking vacuum is used for the first group of animals. According to another variant the pulse length of a pulsating vacuum is different for the first group of animals, wherein the suction phase is shorter.

Preferably, the milking arrangement comprises a memory media for storing information on the milking data for each one of the animals. This is essential in cases where such information is used to determine whether milking may be interrupted in a later milking.

The milking arrangement may comprise hindering means for hindering the animals from leaving the milking positions before the teat cups have been removed from the animals. When the teat cups have been removed from the animals the hindering means may be removed to allow the animals to leave the milking positions. The hindering means may be arranged to be removed simultaneously. This allows the animals to be more easily handled as a group when they have left the milking positions.

The hindering means may be constituted by exit gates from the milking positions, even though it is possible to have the hindering means separated from any exit gates.

According to a second aspect of the invention a method is provided for milking animals. The method comprises the steps of placing at least two animals in a respective milking position and hindering the animals from leaving the milking positions, arranging teat cups on each animal, determining when milking is finished, and removing the teat cups from an animal when milking is finished. The method is characterised in that it also comprises the step of removing the teat cups from all animals that are still being milked when all conditions in a set of conditions are fulfilled, wherein the set of conditions comprises the condition that the teat cups have been removed from a predetermined number of animals and that all animals that are still being milked in an earlier milking, preceding the present milking, must have been milked until milking was substantially finished.

With a method according to the invention the milking may be made more efficient as the milking is interrupted for the animals requiring most time in the milking arrangement. The set of conditions may comprise only the condition mentioned above, but may also comprise other conditions.

The condition set may comprise the condition that the earlier milking must have occurred no earlier than within a maximum number of milkings preceding the present milking. The maximum number of milkings is chosen in order to avoid that any animal gets a disease such as mastitis, which may occur if the animals are never milked until milking is finished.

The maximum number of milkings may preferably be in the range 1-10 milkings and more preferred in the range 2-5 milkings.

As an alternative to or combined with the above mentioned maximum number of milkings a time limit may be used, wherein the earlier milking must have occurred no earlier than within a maximum time limit preceding the present milking. By having a maximum time limit it is possible to take into account different milking frequencies used at different milking arrangements.

The maximum time limit is preferably in the range 15-50 hours and more preferred in the range 20-30 hours. The latter is a proper range when the cows are milked 3 times per day.

Milking may be considered to be finished when the udder is empty or almost empty. The determination of when milking is finished would then be a determination of when the udder is empty or almost empty. Such a determination of when milking is finished may be performed in a variety of ways. The milk flow from the animal in each milking position may be determined during milking. Determination of whether milking is finished may then be determined to be when the milkflow from the animal is below a predetermined threshold. The milk flow may be measured with flow meters. The milk flow may also be measured indirectly by measuring the totally milked volume as a function of the time. In such a case the milk flow is the derivative of the totally milked volume.

Another method of determining when milking is finished would be to measure the volume of the milk that has been milked. When the volume exceeds a predetermined value milking may be determined to be finished. A unique threshold for the milk flow may be arranged for each animal.

The features described in relation to the first aspect of the invention may, where applicable, also be incorporated in a method according to the second aspect of the invention with the same advantages as described above.

In the following embodiments of the present invention will be described with reference to the appended drawings.

### BRIEF DESCRIPTION OF THE DRAWINGS

FIG. 1 shows schematically a milking arrangement according to an embodiment of the present invention comprising a number of milking positions.

FIG. 2 shows schematically a milking arrangement according to another embodiment of the present invention.

FIG. 3 shows in more detail one of the milking positions in the milking arrangement in FIG. 1.

FIG. 4 shows a milking arrangement according to another embodiment of the present invention.

### DESCRIPTION OF EMBODIMENTS OF THE INVENTION

In the different embodiments described below similar features will be denoted with the same reference numerals.

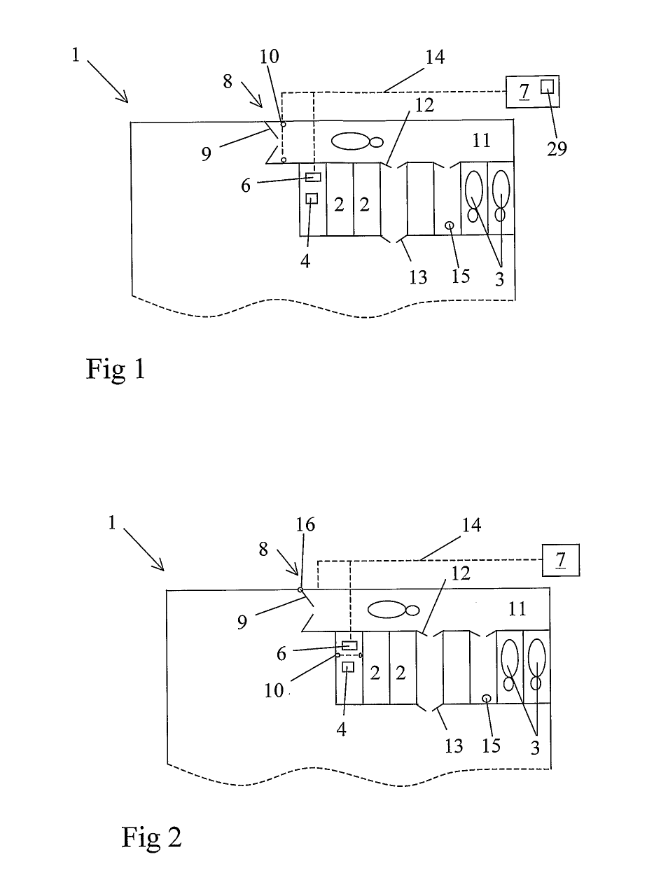

FIG. 1 shows schematically a milking arrangement 1 according to an embodiment of the present invention comprising a number of milking positions 2 for milking of animals 3. The milking arrangement may form part of a milking stall also comprising a feeding area, not shown, for feeding the animals and a resting area, not shown, for allowing the animals to rest. Each one of the milking positions 2 is provided with teat cups 4 for milking of the animals and a removing member 6 for removal of the teat cups 4 from the animals. The removing members 6 are controlled by a control device 7 in the form of a computer.

Animals 3 that enter the milking positions must pass through the access device 8. The access device comprise a first gate 9, which is controlled by the control device, and an animal identification means 10, which is connected to the control device 7. A passage 11 leads from the access device 8 to each one of the milking positions 2. Each milking position 2 is provided with an entrance gate 12 and an exit gate 13. The entrance gates 12 are oneway gates allowing an animal to pass only in the direction from the passage 11 to the milking positions 2. Each one of the entrance gates may be provided with detection means 15 for detection of when an animal enters the respective milking position.

The function of the milking arrangement 1 in FIG. 1 will now be described starting with the description of how animals enter the milking position. When animals 3 are to enter the milking positions 2 they first have to pass through the first gate 9 and the animal identification means 10. When animals enter the milking arrangement 1 all of the exit gates 13 are closed. All entrance gates 12 but one are locked when animals 3 enter the milking positions 2 through the access device 8. When the animals 3 pass the animal identification means 10 they are identified and the information on their identity is sent to the control device 7 where the information is saved in the memory media 29. When the first animal 3 passes through the access device only the entrance gate, being most distant from the access device 8, is unlocked. When the detection means 15 detects that the first animal 3 passes through the entrance gate 12 to the most distant milking position 2 the entrance gate 12 is locked and the entrance gate 12 next most distant from the access device 8 is unlocked. This procedure is continued until all milking positions 2 are filled with animals. With a milking arrangement according to this embodiment the identity of the animals 3 in the milking positions 2 may be determined with certainty. When a sufficient number of animals 3 have passed the animal identification means the first gate is closed. The decision that all milking positions are filled is based on the number of animals that have passed the animal identification means 10 at the access device 8. When the first animal 3 has entered one of the milking positions 2 an operator of the milking arrangement may start to attach teat cups 4 on the animal, whereafter milking of the animal may commence. The application of the teat cups 4 may alternatively start only after all animals have entered the milking positions 2. The control device 7 monitors the milking of the animals 3. When the milk flow from any one of the animals 3 falls below a predetermined threshold the removing member 6 removes the teat cups 4 from that animal 3 and information on the milking is saved in the control device 7. It is also possible to have a removing member 6 for each one of the teats, wherein the milk flow from each individual teat is monitored.

When the teat cups 4 have been removed from all but one remaining animal 3 it is considered whether milking is to be interrupted. To this end the control device 7 retrieves information on previous milkings for the remaining animal that is still being milked. In case the remaining animal, during any one of the last three milkings or 24 hours, has been milked until the milk flow was below the predetermined threshold the removing member 6 removes the teat cups 4 also from the remaining animal 3. When the teat cups 4 have been removed from all animals 3 the exit gates 13 of the milking positions 2 are opened and the animals 3 are released. When the exit gates 13 have been closed again new animals may be let into the milking positions 2.

It is also possible to open the exit gates 13 individually for each milking position 2 after the removing member has removed the teat cups 4 from the animal 3 in a milking position 2.

It is possible to arrange robots for the attachment of the teat cups on the animals.

FIG. 2 shows a milking arrangement 1 according to an alternative embodiment of the present invention. Only the differences between the embodiment shown in FIG. 1 and the embodiment shown in FIG. 2 will be described. In the embodiment shown in FIG. 2 animal identification means 10 are arranged in each one of the milking positions 2. The access device 8 comprises a first gate 9, which is a oneway gate allowing an animal 3 to pass only in the direction into the passage 11. The first gate 9 is provided with a counter 16 which is connected to the control device 7 via a line 14.

In operation of a milking arrangement according to the second embodiment animals pass into the passage 11 through the first gate 9. When a number of animals corresponding to the number of milking positions has been counted by the counter 10, the control device 7 locks the first gate 9. The animals that has passed the first gate 9 are free to enter any one of the milking positions in which there is no animal. The animals 3 are identified by the animal identification means 10 in the milking positions 2.

When the milking positions have been filled with the animal the milking and the interruption of the milking is performed in the same way as was described in relation to FIG. 1 above.

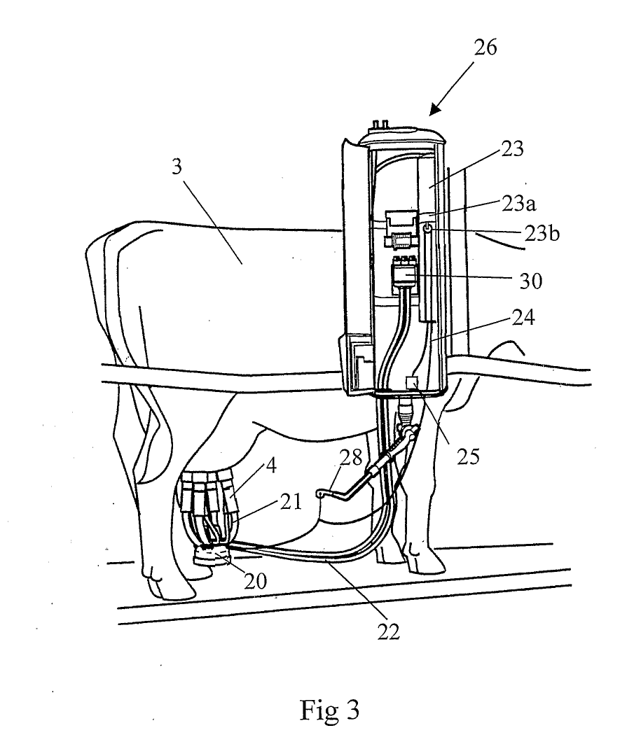

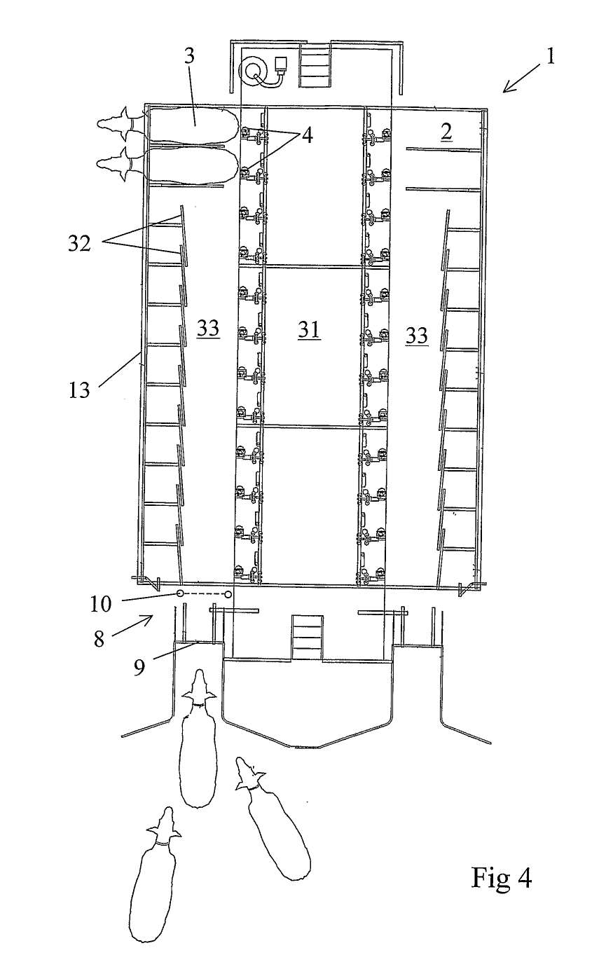

FIG. 3 shows in more detail one of the milking positions in the milking arrangement in FIG. 1 and FIG. 2. The milking position comprises teat cups 4, which are connected to a claw 20 through short milk lines 21. The milk central 20 is in turn connected to milk lines 22 for transportation of the milk to a central milk tank. Flow meters 30 are arranged on the milk lines for measuring the milk flow from the teat cups 4. The removing member 6 comprises an operating cylinder 23 having a movable piston 23a, which via a pulley 23b is connected to an elongated flexible member, which here is a cord 24. A first end of the cord 4 is connected to a locking element 25, which is fixedly arranged inside a cabinet 26 at a bottom surface. The cord 24 has an extension from the locking element 25, via the pulley 23b of the operating cylinder 23 and a suspension member 28, to the claw 20.

When the removing member is activated, a vacuum pump (not disclosed) is used to control the pressure level in a space above the piston 3a in the operating cylinder 3. When the pressure drops in said space, the piston 3a moves in an upward direction. During this motion, the pulley 3b acts on the cord 4 in such a manner that the milking member 1 is pulled from the cow 2 towards the suspension member 8. The removing member comprises a releasable coupling device comprising the locking element 5 and the cord 4, which is releasably connected to the locking element 5. If a pulling load arises in the cord 4 above a certain value, the cord 4 is released from the locking element 5 in such a manner that the cord 4 runs freely through the operating cylinder 3 and the cabinet 6.

FIG. 4 shows in more detail a milking arrangement 1 according to another embodiment of the present invention. The milking arrangement 1 comprises a number of milking positions 2 arranged in two rows with a pit 31 therebetween. The milking positions are arranged for animals 3 to be positioned with their rump towards the pit 31. The milking positions 2 are divided by rotatable walls 32 which are rotatable between a first position in which they divide the milking positions 2 and a second position in which they form an animal passage 33. The milking arrangement 1 further comprises an access device 8 with a first gate 9 and an animal identification means 10. Animals that enter the milking positions 2 must first pass through the access device 8. Teat cups 4 are arranged in the pit 31 behind the rumps of the animals 3. An operator of the milking arrangement 1 who stands in the pit 31 may attach the teat cups 4 on the teats of the animals 3 between the legs of the animals 3. An optional hindering means 13 in the form of a boom is arranged to hinder animals 3 from leaving the milking positions.

The operation of the milking arrangement 1 in FIG. 4 will now be described. In FIG. 4 two animals 3 have already entered their respective milking positions 2. An animal that passes the first gate of the access device 8 is identified by the identification means 10. The animal will then pass through the animal passage 33 formed by the rotatable walls 32 until the animal reaches the last empty milking position 2 where the animal 3 will turn its head towards the hindering means 13 and in doing so will turn the corresponding rotatable wall to its first position so that the animal 3 is enclosed by rotatable walls 32 on both sides. An operator may start to attach teat cups 4 on the animals 3 as soon as they have entered the milking positions 2. The milking, the determination of when milking is finished and the removal of the teat cups 4 from the animals 3 is performed in the same way as was described above. When the teat cups 4 have been removed from all animals 3 the boom is lowered to allow the animals 3 to leave the milking positions 2.

The milking arrangement shown in FIG. 4 is an example of a milking arrangement in which it is not possible to allow new animals 3 to enter the milking positions 2 before all animals 3 in the present milking have left the milking positions 2.

In the embodiments described above only one animal is still being milked when it is considered whether milking is to be interrupted. It is however possible to interrupt milking when more than one animal is still being milked.

It is within the scope of the invention to include a robot for application of the teat cups 4 on the animals 3.

It is possible to arrange the milking positions in other ways from those described in the embodiments above. The milking positions may for example be arranged in a herringbone arrangement.

1. A milking arrangement for simultaneous milking of at least two animals, the milking arrangement comprising:
at least two milking positions, wherein each milking wherein each milking position comprises teat cups for milking an animal, a removing member for removal of the teat cups from the animals and determining means for determining when milking is finished, and wherein the removing members are arranged to remove the teat cups from the animal when milking is finished,
wherein the milking arrangement is arranged to remove the teat cups from all animals that are still being milked, using the removing member, when all conditions in a set of conditions are fulfilled, and
wherein the set of conditions comprises the conditions that the teat cups have been removed from a predetermined number of animals and that all animals that are still being milked in an earlier milking, preceding the present milking, must have been milked until the earlier milking was determined to be substantially finished.

2. A milking arrangement according to claim 1, wherein the set of conditions also comprises the condition that the earlier milking must have occurred no earlier than within a maximum number of milkings preceding the present milking.

3. A milking arrangement according to claim 2, wherein the maximum number of milkings is in the range 2-10 milkings.

4. A milking arrangement according to claim 1, wherein the set of conditions also comprises the condition that the earlier milking must have occurred no earlier than within a maximum time limit preceding the present milking.

5. A milking arrangement according to claim 4, wherein the maximum time limit is in the range 20-50 hours.

6. A milking arrangement according to claim 1, wherein the determining means is arranged to determine the milk flow from the animal in each milking position during milking and wherein milking is determined to be finished when the milk flow from the animal is below a predetermined threshold.

7. A milking arrangement according to claim 6, wherein a unique threshold for the milk flow is arranged for each animal.

8. A milking arrangement according to claim 1, wherein the milking arrangement comprises animal identification means for identifying animals entering the milking positions.

9. A milking arrangement according to claim 1, further comprising an access device, which animals have to pass before entering the milking positions.

10. A milking arrangement according to claim 9, wherein animal identification means are arranged in the access device, identifying animals passing through the access device.

11. A milking arrangement according to claim 8, wherein said animal identification means are arranged in at least one of the milking positions.

12. A milking arrangement according to claim 11 wherein animal identification means are arranged in each one of the milking positions.

13. A milking arrangement according to claim 1, further comprising means for measuring and registering the milking times for each animal.

14. A milking arrangement according to claim 13, wherein the milking arrangement is arranged to indicate milking positions in which animals are present and for which animals any previous milking has taken longer time than for the majority of the animals.

15. A milking arrangement according to claim 13, wherein the milking arrangement is arranged to milk a first group of animals, for which animals any previous milking has taken shorter time than for the majority of the animals, differently from the other animals in the milking arrangement.

16. A milking arrangement according to claim 15, wherein a lower milking vacuum is used for the first group of animals.

17. A milking arrangement according to claim 15, wherein the pulse length of a pulsating vacuum is different for the first group of animals, wherein the suction phase is shorter.

18. A milking arrangement according to claim 1, further comprising a memory media for storing information on the milking data for each one of the animals.

19. A milking arrangement according to claim 1, wherein the predetermined number of animals, from which the teat cups have been removed is one.

20. A milking arrangement according to claim 1, further comprising hindering means for hindering the animals from leaving the milking positions.

21. A milking arrangement according to claim 20, wherein the hindering means include exit gates.

22. A method for simultaneous milking of at least two animals comprising the steps of:
placing at least two animals in a respective milking position;
arranging teat cups on each animal;
determining when milking is finished;
removing the teat cups from an animal when milking is finished; and
removing the teat cups from the animals that are still being milked when all conditions in a set of conditions are fulfilled, wherein the set of conditions comprises the conditions that the teat cups have been removed from a predetermined number of animals and that all animals that are still being milked in an earlier milking, preceding the present milking, must have been milked until the milking was determined to be substantially finished.

23. A method according to claim 22, wherein the earlier milking must have occurred no earlier than within a maximum number of milkings preceding the present milking.

24. A method according to claim 22, wherein the maximum number of milking is within the range 2-10 milkings.

25. A method according to claim 22, wherein the earlier milking must have occurred no earlier than within a maximum time limit preceding the present milking.

26. A method according to claim 25, wherein the maximum time limit is in the range 15-50 hours.

27. A method according to claim 22, further comprising the steps of determining the milk flow from the animal in each milking position during milking and determining milking to be finished when the milk flow from the animal is below a predetermined threshold.

28. A method according to claim 27, wherein a unique threshold for the milk flow is arranged for each animal.

29. A method according to claim 22, further comprising the step of identifying the animals entering the milking positions.

30. A method according to claim 29, wherein the animals passes an access device before entering the milking positions.

31. A milking arrangement according to claim 30, wherein the animals are identified when they pass through the access device.

32. A milking arrangement according to claim 31, wherein the animals are identified in at least one of the milking positions.

33. A method according to claim 22, further comprising the step of identifying the animals are identified in each one of the milking positions.

34. A method according to claim 22, wherein the predetermined number of animals, from which the teat cups have been removed is one.
